(19) United States
(12) Patent Application Publication
(10) Pub. No.: US 2023/0299871 A1
(43) Pub. Date: Sep. 21, 2023

(54) Hybrid Link Adaptation For Improved Unmanned Aerial Vehicle Communication

(71) Applicant: Skydio, Inc., San Mateo, CA (US)

(72) Inventors: Eyal Hochdorf, Palo Alto, CA (US); Kuldeep Singh Gill, Pacifica, CA (US)

(73) Assignee: Skydio, Inc., San Mateo, CA (US)

(21) Appl. No.: 18/124,493

(22) Filed: Mar. 21, 2023

Related U.S. Application Data
(60) Provisional application No. 63/321,849, filed on Mar. 21, 2022.

(51) Int. Cl. H04L 1/00; H04B 7/185

(52) U.S. Cl. CPC H04L 1/0003; H04B 7/18506

(57) ABSTRACT

Technology for operating an unmanned aerial vehicle (UAV) communication system is disclosed herein that allows an UAV communication system to transition between modulation modes. In various implementations, a wireless radio of the UAV communication system operates in a dynamic modulation mode such that the wireless radio dynamically adjusts the modulation rate of a signal within a range of possible modulation rates. The wireless radio transitions to a fixed modulation mode, based at least on a current modulation rate of the signal reaching a low end of the range of possible modulation rates. When in the fixed modulation mode, the wireless radio holds the modulation rate at the low end of the range of possible modulation rates. The wireless radio returns to the dynamic modulation mode based on the quality of the signal.

### CROSS-REFERENCE TO RELATED APPLICATIONS

The present application claims priority to U.S. Provisional Pat. Application No. 63/321,849 entitled “HYBRID LINK ADAPTATION FOR IMPROVED UAV COMMUNICATION” filed on Mar. 21, 2022. This prior application is hereby incorporated herein by reference in its entirety.

### TECHNICAL FIELD

Various implementations of the present technology relate to unmanned aerial vehicles (UAVs) and, in particular, to the integration of hybrid link adaptation in UAV communications.

### BACKGROUND

Unmanned aerial vehicles (UAVs), also known as drones, are commonly used to capture video, images, or other data from a vantage point or location that might otherwise be difficult to reach. Drones are used for various purposes, such as scientific exploration, military operations, intelligence gathering, and the like. UAVs for both commercial and recreational use include a communication system that allows the UAV to transmit real-time data to a receiving device. Typically, UAV communication systems employ a rate adaptation algorithm (RAA) to determine a transmission rate that maximizes the throughput of data. In some applications, the RAA aims to improve the quality of the signal by determining the appropriate modulation and coding scheme (MCS) at which the UAV should transmit the signal. The MCS of a signal describes the amount of useful bits that may be transmitted between the UAV and the receiving device, such that a higher MCS (e.g., MCS6, MCS7, etc.) transmits a larger amount of useful bits while a lower MCS (e.g., MCS0, MCS1, etc.) transmits a smaller amount of useful bits.

In operation, the RAA determines the appropriate MCS of a signal based on real-time characteristics of the drone. For example, such real-time characteristics may include the drone’s location relative to the receiving device. At close-range scenarios, the RAA employs a higher MCS, while at long-range scenarios, the RAA employs a lower MCS. When at the longest of ranges, the RAA employs MCS0, the lowest available MCS. Simultaneously, the RAA attempts to optimize the data throughput by evaluating if a higher MCS may be employed.

Consequently, the continuous effort of optimizing the data throughput of a UAV, when the current conditions call for MCS0, results in performance degradation. In other words, the RAA is unable to recognize when MCS0 is the only acceptable MCS. As a result, the RAA wastes resources by attempting to employ a higher MCS.

### OVERVIEW

Technology is disclosed herein for operating an unmanned aerial vehicle (UAV) communication system. In various implementations, a wireless radio of the UAV operates in a dynamic modulation mode. When in the dynamic modulation mode, the wireless radio dynamically adjusts a modulation rate of a signal transmitted by the UAV within a range of possible modulation rates. In an implementation, the wireless radio transitions the UAV from the dynamic modulation mode to a fixed modulation mode based on the current modulation rate of the signal reaching a low end of the range of possible modulation rates. When in the fixed modulation mode, the wireless radio transmits signals at a specified modulation rate. Once the fixed modulation mode is no longer required, the wireless radio returns to the dynamic modulation mode. In an implementation, the wireless radio returns to the dynamic modulation mode based on the quality of the signal.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operating environment of an unmanned aerial vehicle (UAV) in an implementation.

FIG. 2 illustrates a method of operation of a UAV communication system in an implementation.

FIG. 3 illustrates a software architecture for a UAV communication system in an implementation.

FIG. 4 illustrates an exemplary process of a UAV communication system in an implementation.

FIGS. 5A-5B illustrates an operational scenario of a UAV in an implementation.

FIG. 6 illustrates a results graph in an implementation.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Systems, methods, and devices are disclosed herein to improve both the range and data throughput of unmanned aerial vehicle (UAV) communications. In an implementation, a communication system of the UAV employs hybrid link adaptation. Hybrid link adaptation is a technique that allows a UAV to determine an appropriate modulation mode to transmit data, such that the modulation modes include a dynamic modulation mode and a fixed modulation mode. When in the dynamic modulation mode, the UAV employs a rate adaptation algorithm (RAA). The RAA dynamically adjusts the current modulation and coding scheme (MCS) of the transmitted signal based on real-time characteristics of the UAV. Alternatively, when in the fixed modulation mode, the UAV is only allowed to transmit signals at a specified MCS.

Typically, the UAV communication system operates in the dynamic modulation mode and only transitions to the fixed modulation mode when the signal quality degrades below a specified threshold. In operation, the RAA of the dynamic modulation mode aims to improve the throughput of data by increasing the MCS, thus higher MCSs correspond to a good signal quality while lower MCSs correspond to a poor signal quality. As a result, the UAV communication system only transitions from the dynamic modulation mode to the fixed modulation mode when the RAA employs MCS0 (i.e., the lowest MCS allowed by the system). In an implementation, the UAV transitions from the dynamic modulation mode to the fixed modulation mode based on a comparison of the success ratios of the currently employed modulation rate (i.e., MCS0) against the previously employed modulation rates (i.e., MCS1, MCS2, etc.). Success ratios of a modulation rate describe the amount of received acknowledgments generated by a receiving computing device in response to the transmitted signal. In an implementation, if the success ratio of MCS0 is greater than the success ratios of the one or more previously employed MCSs, the UAV communication system transitions to the fixed modulation mode. Else, the UAV remains in the dynamic modulation mode.

In an implementation, when operating in the fixed modulation mode, the UAV communication system only transmits signals with MCS0. As a result, the UAV communication system avoids unnecessary allocations of resources. Meaning, when in the fixed modulation mode, the UAV communication system no longer employs the RAA, thusly allowing the UAV to increase reliability of packet transmission.

In an implementation, the UAV communication system transitions from the fixed modulation mode, back to the dynamic modulation mode based on a signal-to-noise ratio (SNR) of the transmitted signal. While operating in the fixed modulation mode, the UAV communication system calculates the SNR of the transmitted signal. If the SNR is above a designated threshold, the UAV communication system returns to the dynamic modulation mode. Else, the UAV communication system remains in the fixed modulation mode.

In an operational example, the communication system of the UAV first operates under the dynamic modulation mode. When in the dynamic modulation mode, the UAV communication system employs the RAA to determine the best MCS to transmit a generated signal. In an implementation, the RAA determines the best MCS based on real-time characteristics of the UAV. For example, such real-time characteristics may include the probability of a data packet being received by an end user device with the determined MCS. In an implementation, signals generated by the UAV communication system carry data packets of information to be received by an end user device. In operation, the RAA measures the probability of data packets being received by the end user device to determine the appropriate MCS to transmit the signal. If the probability of the data packet being received is low, the RAA reduces the MCS to maintain the quality of the signal. Alternatively, if the probability of the data packet being received is high enough, the RAA increases the MCS to increase the throughput of data. Else, the RAA maintains the current MCS.

Continuing the operational example, when the RAA employs MCS0, the UAV communication system evaluates the success ratios of previously employed MCSs as compared to the success ratio of the currently employed MCS0. For example, at the beginning of operation, the RAA may employ MCS4. As environmental conditions change and the probability of data packets being received decreases, the RAA reduces the MCS. Once environmental conditions force the RAA to employ MCS0, the UAV communication system computes the success ratios of the currently employed MCS0 and the previously employed MCS4, MCS3, MCS2, and MCS1 to determine the appropriate modulation mode. Success ratios of the employed MCSs describe the amount of received acknowledgments generated by an end user device in response to the transmitted signal. If the success ratio of MCS0 is greater than the success ratios of MCS4, MCS3, MCS2, and MCS1, the UAV communication system transitions to the fixed modulation mode. Else, the UAV communication system remains in the dynamic modulation mode.

When in the fixed modulation mode, the UAV communication system transmits signals with MCS0. During operation, the UAV communication system computes the SNR of the transmitted signal. If the SNR is below a designated threshold, the UAV communication system remains in the fixed modulation mode. Conversely, if the SNR is above the designated threshold, the UAV communication system returns to the dynamic modulation mode.

Various technical effects of the disclosed technology may be appreciated from the present disclosure. For example, the integration of hybrid link adaptation within a UAV communication system improves the throughput of data by approximately 25% by allowing the UAV communication system to transition between modulation modes. Further, the range of UAV communication systems has been extended due to the integration of hybrid link adaptation. Finally, the forward error correction (FEC) code-rate is reduced.

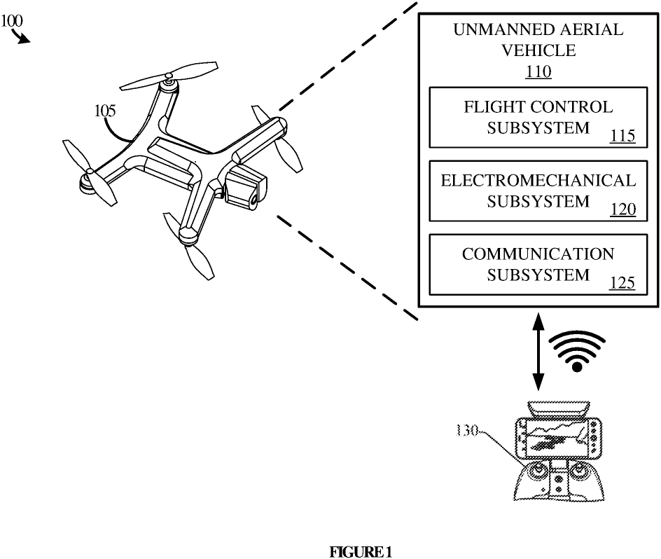

Referring now to the drawings, FIG. 1 illustrates an exemplary operating environment for employing hybrid link adaptation, herein referred to as operating environment 100. Operating environment 100 includes unmanned aerial vehicle (UAV) 105 and remote control 130. Operating environment 100 may be representative of any environment that hosts the communication between a UAV and its corresponding controller. For example, such an environment may include, but is not limited to, a hazardous area that requires inspection by a UAV, as directed by an end user device.

UAV 105 is representative of a device that collects and transmits data to remote control 130 by employing hybrid link adaptation. UAV 105 employs hybrid link adaptation via operational architecture 110. Operational architecture 110 is representative of the internal hardware and software components of UAV 105. Operational architecture 110 broadly includes flight controller subsystem 115, electromechanical subsystem 120, and communication subsystem 125. Flight controller subsystem 115 may include a circuit board housing one or more microprocessors, also known as a flight controller, that control various aspects of drone operation. Electromechanical subsystem 120 may include an electronic speed controller unit and various rotors, power supplies, and the like. Communication subsystem 125 may include a wireless radio to transmit signals over Wi-Fi to remote control 130 and software to employ hybrid link adaptation.

Software that employs hybrid link adaptation allows communication subsystem 125 to operate in two modulation modes, such that the modulation modes include a dynamic modulation mode and a fixed modulation mode. When operating in the dynamic modulation mode, communication subsystem 125 employs a rate adaptation algorithm (RAA) to dynamically adjust the modulation and coding scheme (MCS) of the transmitted signal. In operation, the RAA either increases or decreases the MCS based on real-time factors. For example, such real-time factors may include a quality of the signal or a current distance between UAV 105 and remote control 130. As a result, when conditions change, the RAA adjusts the MCS. Alternatively, when operating in the fixed modulation mode, communication subsystem 125 transmits signals with a fixed MCS (e.g., MCS0). In operation, communication subsystem 125 transitions between the dynamic modulation mode and the fixed modulation mode based on received communications from remote control 130.

Remote control 130 is representative of an end user device that communicates with UAV 105 over Wi-Fi. In operation, remote control 130 sends signals to and receives signals from UAV 105. For example, remote control 130 may receive signals carrying data collected by UAV 105 and generated by communication subsystem 125. In response to the received signals, remote control 130 generates acknowledgments to be delivered to communication subsystem 125. Acknowledgments generated by remote control 130 allow software of communication subsystem 125 to determine the appropriate modulation mode for communication subsystem 125 to operate in.

In a brief operational scenario, UAV 105 collects data to be transmitted to remote control 130. Data collected by UAV 105 is formatted into a signal via communication subsystem 125. At the beginning of operation, communication subsystem 125 operates under the dynamic modulation mode such that communication subsystem 125 employs the RAA. In an implementation, the RAA determines the best MCS to transmit the signal based on the probability of the signal being received by remote control 130. If the probability of the signal being received by remote control 130 is high, the RAA will increase the MCS to improve the throughput of data. Alternatively, if the probability of the signal being received by remote control 130 is low, the RAA will decrease the MCS to improve the probability of the signal being received.

While operating in the dynamic modulation mode, software of communication subsystem 125 monitors for when the RAA employs MCS0. In response to the RAA employing MCS0, software of communication subsystem 125 computes the success ratios of the signals employed with MCS0 as compared to the signals employed with previous MCSs to determine if communication subsystem 125 should transition to the fixed modulation mode. Software of communication subsystem 125 computes the success ratios of the employed MCSs by determining the amount of acknowledgments received from remote control 130 in operation. If the success ratio of MCS0 is greater than the success ratios of the previously employed MCSs, communication subsystem 125 transitions to the fixed modulation mode. Else, communication subsystem 125 remains in the dynamic modulation mode.

When operating in the fixed modulation mode, communication subsystem 125 transmits signals with MCS0. During operation, software of communication subsystem 125 measures the signal-to-noise ratio (SNR) of the transmitted signals. If the SNR of the signal is below a designated threshold, communication subsystem 125 will continue to operate in the fixed modulation mode. Alternatively, if the SNR of the signal is above the designated threshold, communication subsystem 125 will transition back to the dynamic modulation mode.

Communication subsystem 125 will transition back in forth from the dynamic modulation mode and the fixed modulation mode based on the current conditions. Majority of the time, communication subsystem 125 operates under the dynamic modulation mode. Once the dynamic modulation mode employs MCS0, software of communication subsystem 125 determines if the fixed modulation mode is required. If not required, communication subsystem 125 will continue to operate under the dynamic modulation mode and the software of communication subsystem 125 will continue to monitor for when MCS0 is employed. Alternatively, if the fixed modulation mode is required, communication subsystem 125 will transition to the fixed modulation mode and the software of communication subsystem 125 will begin computing the SNR of the signal. Once the SNR of the signal reaches a predetermined threshold, communication subsystem 125 transitions back to the dynamic modulation mode.

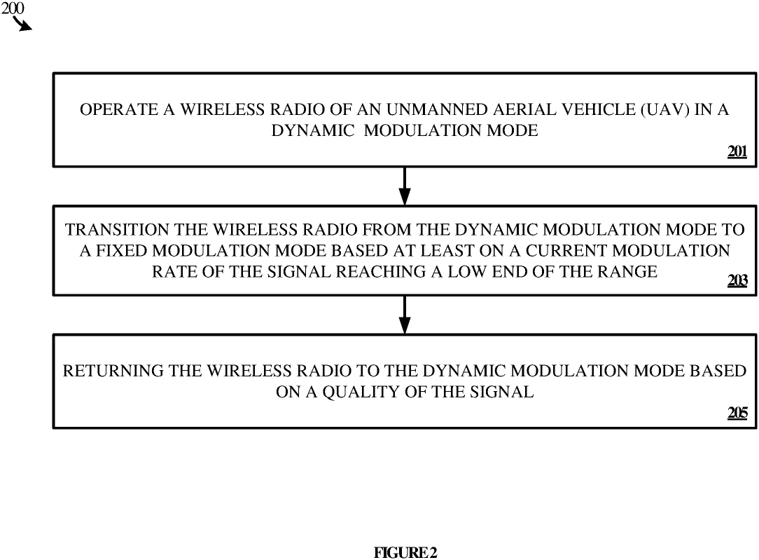

FIG. 2 illustrates a method for operating a UAV communication system (e.g., communication subsystem 125), herein referred to as method 200. Method 200 may be implemented in the context of program instructions, that when executed by a suitable processing system, direct the processing system to operate as follows, referring parenthetically to the steps in FIG. 2.

To begin, the processing system directs a wireless radio of the UAV communication system to operate in a dynamic modulation mode (step 201). When in the dynamic modulation mode, the wireless radio of the UAV communication system dynamically adjusts the modulation rates of the transmitted signals within a range of possible modulation rates. In an implementation, once the wireless radio employs the lowest possible modulation rate allowed by the dynamic modulation mode, the UAV communication system compares the success ratios of the lowest possible modulation rate with the success ratios of the previously employed modulation rates. If the success ratio of the lowest possible modulation rate is greater than the success ratios of the previously employed modulation rates, the processing system transitions the wireless radio of the UAV communication system to a fixed modulation mode (step 203). Else, the wireless radio of the UAV communication system remains in the dynamic modulation mode.

When in the fixed modulation mode, the wireless radio of the UAV communication system transmits the signal at the lowest possible modulation rate allowed by the dynamic modulation mode. During operation, the UAV communication system monitors the signal quality of the transmitted signal such that the signal quality is based on the SNR of the signal. If the SNR of the signal is above a specified threshold, the processing system directs the wireless radio to return to the dynamic modulation mode (step 205). Else, the wireless radio remains in the fixed modulation mode, until the SNR rises above the specified threshold.

Referring back to FIG. 1, the following describes a brief example of method 200 in the context of operational environment 100. In operation, communication subsystem 125 operates in a dynamic modulation mode, such that the RAA dynamically adjusts the MCS of the transmitted signal. When the RAA employs MCS0, software of communication subsystem 125 computes the success ratio of MCS0 as compared to the success ratios of previously employed MCSs. If the success ratio of MCS0 is greater than the success ratios of the previously employed MCSs, communication subsystem 125 transitions to a fixed modulation mode. While operating in the fixed modulation mode, communication subsystem 125 transmits signals with MCS0. During operation, software of communication subsystem 125 computes the SNR of the transmitted signal. If the SNR of the transmitted signal correlates with a poor signal quality, communication subsystem 125 remains in the fixed modulation mode. Alternatively, if the SNR of the transmitted signal correlates with a good signal quality, communication subsystem 125 returns to the dynamic modulation mode.

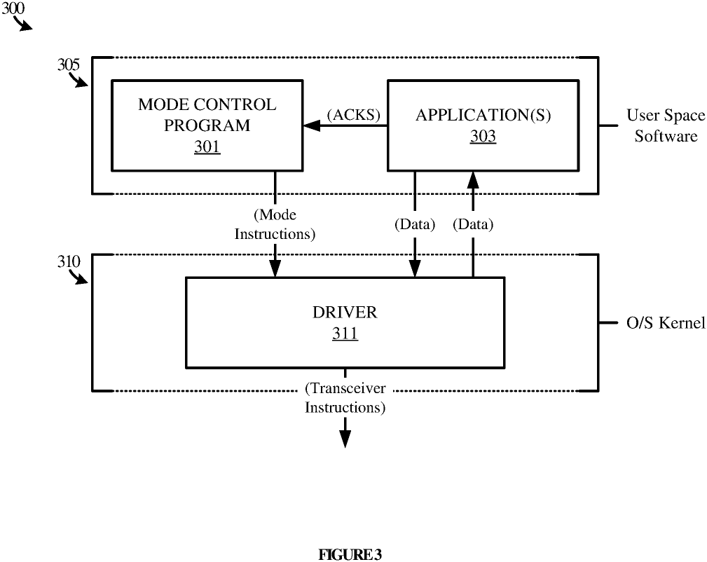

Now turning to the next figure, FIG. 3 illustrates an exemplary software architecture for a UAV operating system herein referred to as software architecture 300. Software architecture 300 is representative of the internal software components required by a UAV communication system (e.g., communication subsystem 125) to employ hybrid link adaptation. Software architecture 300 broadly includes user space 305 and kernel 310. User space 305 and kernel 310 represent the sections of the UAV operating system which allow the UAV communication system to implement hybrid link adaptation.

User space 305 is representative of a virtual memory that stores program instructions related to the application software of the UAV operating system. User space 305 includes mode control program 301 and application programs 303. Mode control program 301 is representative of the software used to integrate hybrid link adaptation. More specifically, mode control program 301 determines if the UAV communication system operates in the dynamic modulation mode or the fixed modulation mode. In an implementation, when operating in the dynamic modulation mode, mode control program 301 employs an RAA to determine the appropriate MCS to transmit a generated signal. Alternatively, when operating in the fixed modulation mode, mode control program 301 directs the UAV communication system to transmit signals with MCS0 exclusively. Application programs 303 is representative of other application software used by the UAV operating system. In an implementation, mode control program 301 communicates with application programs 303 to determine the modulation mode of the UAV communication system.

Kernel 310 is representative of a virtual memory that stores program instructions that maintain the operations between the software and hardware components of the UAV. Kernel 310 broadly includes driver 311. Driver 311 is representative of the software used to drive communications between systems of the UAV. For example, driver 311 communicates with the software of user space 305 to determine the appropriate modulation mode for a UAV communication system. Further, driver 311 provides instructions to a transceiver of the UAV communication system to employ the determined modulation mode.

In operation, application programs 303 and driver 311 communicate to perform functions of the UAV. For example, driver 303 may communicate flight instructions to application programs 303 to control the flight path of the UAV. Alternatively, application programs 303 may communicate image data to driver 311 to generate a signal for an end user device. During the communications between application programs 303 and driver 311, mode control program 301 evaluates the quality of the transmitted signals to determine the appropriate modulation mode for the UAV communication system.

In an implementation, mode control program 301 evaluates the quality of the transmitted signal based on the number of received acknowledgments generated by an end user device in response to the employed MCS. In operation, application programs 303 delivers the received acknowledgments to mode control program 301 to compute the success ratio of the currently employed MCS. If operating in the dynamic modulation mode, and the currently employed MCS is greater than MCS0, the RAA of mode control program 301 determines whether the MCS needs to be increased or decreased. Conversely, if operating in the dynamic modulation mode, and the currently employed MCS is MCS0, mode control program 301 determines whether the fixed modulation mode is required. When the fixed modulation mode is required, mode control program 301 instructs driver 311 to transition to the fixed modulation mode.

In another implementation, mode control program 301 evaluates the quality of the transmitted signal based on the SNR of the signal. For example, when operating in the fixed modulation mode, mode control program 301 computes the SNR of the transmitted signal. If the SNR is above a predetermined threshold, mode control program 301 instructs driver 311 to transition back to the dynamic modulation mode. Else, mode control program 301 continues to compute the SNR and the UAV communication system remains in the fixed modulation mode until the SNR rises above the predetermined threshold.

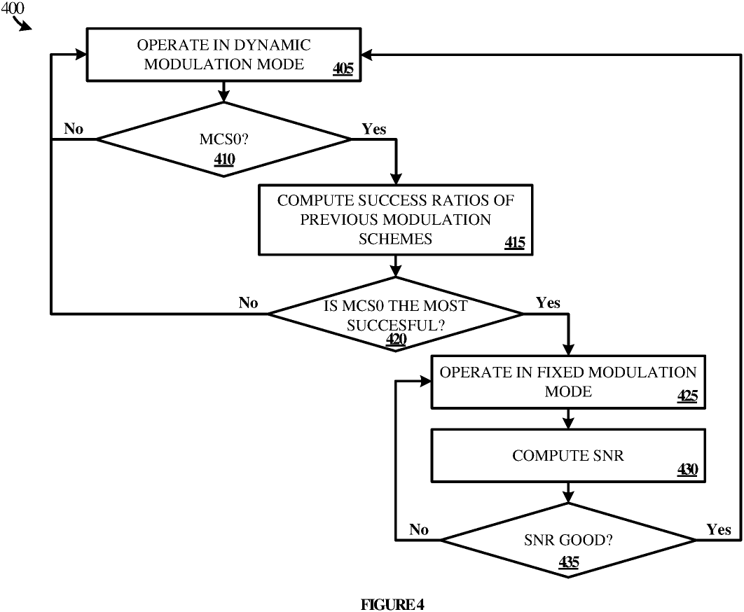

FIG. 4 illustrates a flowchart describing a process to determine the appropriate modulation mode for a UAV communication system, herein referred to as process 400. Process 400 may be employed in the context of program instructions (mode control program 305), that when executed by a suitable processing system (e.g., communication system 125), direct the processing system to operate as follows, referring parenthetically to the steps in FIG. 4.

To begin, the UAV communication system operates in a dynamic modulation mode (step 405). When in the dynamic modulation mode, the UAV communication system employs an RAA to dynamically adjust the MCS of the transmitted signal. During operation, software of the UAV communication system monitors for when the RAA employs MCS0 (step 410). If the RAA does not employ MCS0, the UAV communication system continues to operate in the dynamic modulation mode. Alternatively, if the UAV communication system does employ MCS0, software of the UAV communication system computes the success ratios of the previously employed MCSs (step 415).

Upon determining the success ratios of the previously employed MCSs, software of the UAV communication system determines whether or not MCS0 is the most successful modulation rate (step 420). If MCS0 is not the most successful modulation rate, the UAV communication system continues to operate in the dynamic modulation mode. Conversely, if MCS0 is the most successful modulation rate, the UAV communication system transitions to operate in a fixed modulation mode (step 425).

While in the fixed modulation mode, software of the UAV communication system computes the SNR of the transmitted signal (step 430). Next, software of the UAV communication system determines if the SNR of the transmitted signal reflects a good signal quality (step 435). If the SNR reflects a poor signal quality, the UAV communication system continues to operate in the fixed modulation mode. Alternatively, if the SNR reflects a good signal quality, the UAV communication system returns to the dynamic modulation mode.

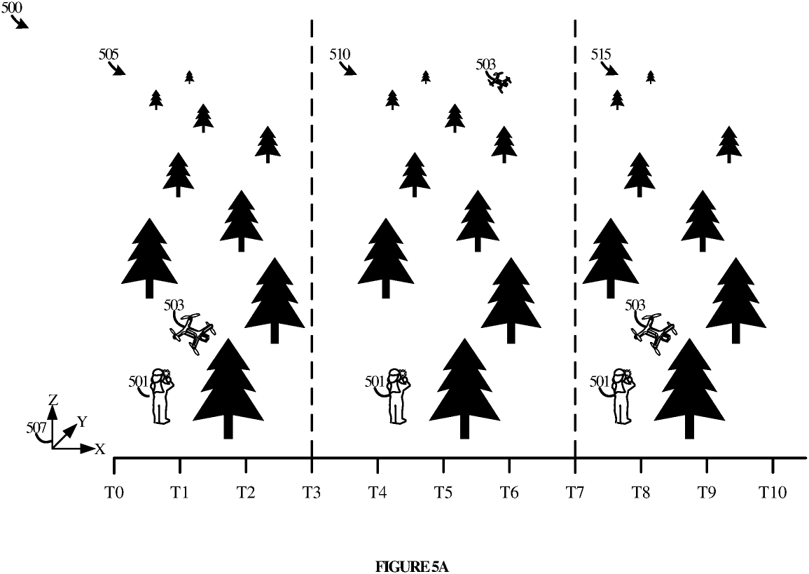

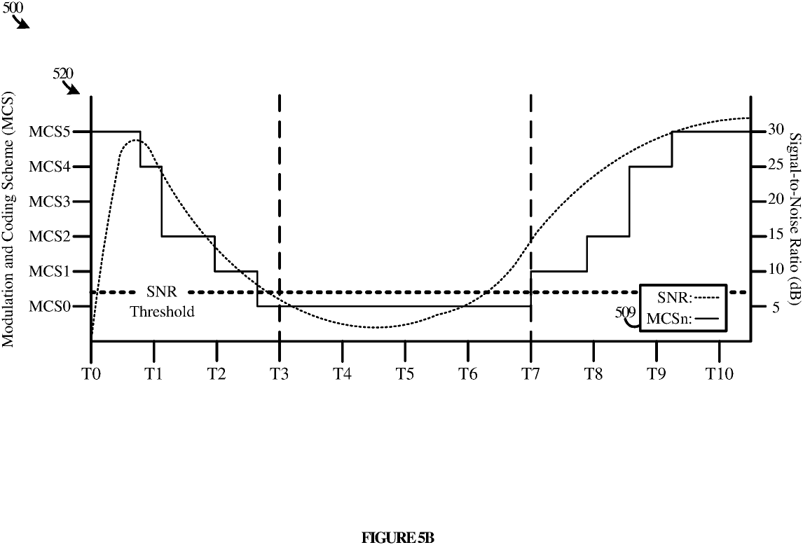

FIGS. 5A-5B illustrate an operational scenario of a UAV employing hybrid link adaptation, herein referred to as operational scenario 500. Operational scenario 500 includes two stages, as differentiated by FIGS. 5A and 5B, such that FIG. 5A depicts an example environment for a UAV, while FIG. 5B depicts results data of the UAV during operation.

Now turning to FIG. 5A, the first stage of operational scenario 500 illustrates the operations of a UAV over a period of time. Operational scenario 500 includes user 501, UAV 503, and axis 507. Further operational scenario 500 includes environment 505, environment 510, and environment 515. Environments 505, 510, and 515 depict the same environment at different points in time to show how different operational conditions affect the modulation mode of UAV 503, later discussed in FIG. 5B.

In an implementation, user 501 communicates with UAV 503 via a remote control, such that the remote control sends commands to UAV 503 while UAV 503 sends data to the remote control. For example, user 501 may send flight commands to UAV 503, while UAV 503 may send image data to user 501.

In an operational example, environment 505 displays user 501 directing UAV 503 to fly at a far range, as shown by the transition from environment 505 to environment 510. Continuing the operational example, environment 510 displays user 501 directing UAV 503 to return to a closer range, as shown by the transition from environment 510 to environment 515. As a result of the changing environmental conditions, UAV 503 evaluates the quality of the transmitted signal to determine the appropriate modulation mode to transmit data.

Now turning to the second stage of operational scenario 500, FIG. 5B illustrates a graph depicting the relationship between the SNR of a signal and the modulation mode of UAV 503, herein referred to as graph 520. Graph 520 includes legend 509 depicting the difference in data types such that the SNR of the transmitted signal is represented as a dotted line, while the employed MCS of the transmitted signal is represented as a solid line.

In a first stage of operation (time T0 to time T3), where user 501 directs UAV 503 to fly at a far range, the UAV communication system reduces the MCS of the transmitted signal. Once the employed MCS is MCS0, the UAV communication system evaluates the SNR of the signal to determine whether or not the fixed modulation mode is required. As shown by graph 520, when MCS0 is employed, the SNR of the transmitted signal falls below the SNR threshold, which means the fixed modulation mode is required.

In a second stage of operation (time T3 to T7), where user 501 directs UAV 503 to return to a closer range, the UAV communication system operates under the fixed modulation mode. While in the fixed modulation mode, the UAV communication system continuously monitors the SNR of the transmitted signal. Once the SNR is above the designated threshold, the UAV communication system transitions back to the dynamic modulation mode.

In a final stage of operation (time T7 to T10), where UAV 503 has returned to a close range, the UAV communication system operates in the dynamic modulation mode. More specifically the UAV communication system employs the RAA to determine the best MCS to transmit the signal. It should be noted that values used in operational scenario 500 are used for the purpose of description and do not signify actual data.

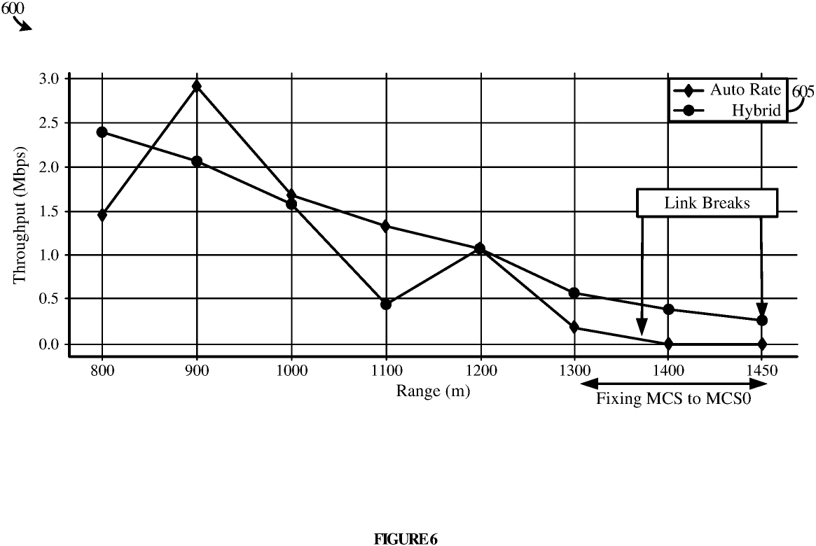

FIG. 6 illustrates graph 600 which compares the throughput of data by a UAV communication system that employs an auto rate as compared to a UAV communication system that employs hybrid link adaptation. Graph 600 includes legend 605 which differentiates data of UAV communication systems that employ auto rates versus UAV communication systems that employ hybrid link adaptation. It should be noted, a UAV communication system that employs an auto rate exclusively employs an RAA.

As graph 600 shows, by fixing the MCS to MCS0, the UAV communication system is able to increase the performance gain of the system. Meaning, at the edge of coverage, UAV communication systems that employ hybrid link adaptation are able to improve the throughput of data, as compared to UAV communication systems that employ auto rates.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

In various implementations, the systems, methods, processes, and operational scenarios may be implemented in computer software executed by a processing system in the context of an unmanned aerial vehicle, a remote-control device, or any other type of device capable of executing software such as computers and mobile phones. The processing system may load and execute the software from a storage system or may be pre-configured with the software. The software includes and implements a process for determining a modulation mode discussed with respect to the preceding Figures, such as method 200 and process 400. When executed by the processing system, the software directs the processing system to operate as described herein for at least the various processes, operational scenarios, and sequences discussed in the foregoing implementations.

Exemplary processing system may comprise a micro-processor and other circuitry that retrieves and executes software from storage. The processing system may be implemented within a single processing device but may also be distributed across multiple processing devices or sub-systems that cooperate in executing program instructions. Examples of processing systems include general purpose central processing units, graphical processing units, application specific processors, and logic devices, as well as any other type of processing device, combinations, or variations thereof.

An exemplary storage system may comprise any computer readable storage media readable by a processing system and capable of storing software. The storage system may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

The software may be implemented in program instructions and among other functions may, when executed by a processing system, direct the processing system to operate as described with respect to the various operational scenarios, sequences, and processes illustrated herein. In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. The software may include additional processes, programs, or components, such as operating system software, virtualization software, or other application software. The software may also comprise firmware or some other form of machine-readable processing instructions executable by a suitable processing system.

In general, the software may, when loaded into a processing system and executed, transform a suitable apparatus, system, or device overall from a general-purpose computing system into a special-purpose computing system as described herein. Encoding the software on a storage system may transform the physical structure of the storage system. The specific transformation of the physical structure may depend on various factors in different implementations of this description. Examples of such factors may include, but are not limited to, the technology used to implement the storage media of the storage system and whether the computer-storage media are characterized as primary or secondary storage, as well as other factors.

For example, if the computer readable storage media are implemented as semiconductor-based memory, the software may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

It may be further appreciated that the unmanned aerial vehicles, remote-control devices, or other devices in which aspects of the present invention may be embodied, may include a communication interface system. The communication interface system may include communication connections and devices that allow for communication with other computing systems and devices (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between such systems and devices may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

The unmanned aerial vehicles, remote-control devices, or other devices in which aspects of the present technology may be embodied, may include a user interface system. A user interface system may any one or more of a joystick, a keyboard, a mouse, a voice input device, a touch input device for receiving a touch gesture from a user, a motion input device for detecting non-touch gestures and other motions by a user, and other comparable input devices and associated processing elements capable of receiving user input from a user (e.g., joystick toggles). Output devices such as a display, speakers, haptic devices, and other types of output devices may also be included in the user interface system. In some cases, the input and output devices may be combined in a single device, such as a display capable of displaying images and receiving touch gestures. The aforementioned user input and output devices are well known in the art and need not be discussed at length here. The user interface system may also include associated user interface software executable by a suitable processing system in support of the various user input and output devices discussed above. Separately or in conjunction with each other and other hardware and software elements, the user interface software and user interface devices may support a graphical user interface, a natural user interface, or any other type of user interface.

Unless the context clearly requires otherwise, throughout the description and the claims, the words “comprise,” “comprising,” “such as,” and “the like” are to be construed in an inclusive sense, as opposed to an exclusive or exhaustive sense, that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method of operating an unmanned aerial vehicle (UAV), the method comprising:
operating a wireless radio of the UAV in a dynamic modulation mode, wherein the wireless radio, when in the dynamic modulation mode, dynamically adjusts a modulation rate of a signal within a range of possible modulation rates;
transitioning the wireless radio from the dynamic modulation mode to a fixed modulation mode based at least on a current modulation rate of the signal reaching a low end of the range, wherein the wireless radio, when in the fixed modulation mode, holds the modulation rate of the signal at the low end of the range; and
returning the wireless radio to the dynamic modulation mode based on a quality of the signal.

2. The method of claim 1, wherein transitioning the wireless radio from the dynamic modulation mode to the fixed modulation mode is further based on a success ratio of a current modulation rate at the low end of the range relative to the success ratios of one or more previous modulation rates.

3. The method of claim 2, wherein the success ratio of a modulation rate is based on an amount of received acknowledgments generated by a receiving computing device in response to the employed modulation rate of the UAV.

4. The method of claim 1 wherein the quality of the signal is based on a signal-to-noise ratio (SNR) of the signal.

5. The method of claim 4 wherein returning the wireless radio to the dynamic modulation mode is further based on an SNR threshold.

6. The method of claim 1 further comprising of the UAV capturing images while in flight and encoding the images into the signal.

7. The method of claim 1 wherein the low end of the range of possible modulation rates comprises a lowest possible modulation rate allowed by the UAV.

8. An unmanned aerial vehicle (UAV) comprising:
a flight control subsystem;
an electromechanical subsystem coupled with the flight control subsystem and configured to fly the unmanned aerial vehicle; and
a communication subsystem over which the UAV communicates one or more other elements;
wherein the communication subsystem is configured to:
operate a wireless radio of the UAV in a dynamic modulation mode, wherein the wireless radio, when in the dynamic modulation mode, dynamically adjusts a modulation rate of a signal within a range of possible modulation rates;
transition the wireless radio from the dynamic modulation mode to a fixed modulation mode based at least on a current modulation rate of the signal reaching a low end of the range, wherein the wireless radio, when in the fixed modulation mode, holds the modulation rate of the signal at the low end of the range; and
return the wireless radio to the dynamic modulation mode based on a quality of the signal.

9. The UAV of claim 8, wherein to transition the wireless radio from the dynamic modulation mode to the fixed modulation mode is further based on a success ratio of a current modulation rate at the low end of the range relative to the success ratios of one or more previous modulation rates.

10. The UAV of claim 9, wherein the success ratio of a modulation rate is based on an amount of received acknowledgments generated by a receiving computing device in response to the employed modulation rate of the UAV.

11. The UAV of claim 8, wherein the quality of the signal is based on a signal-to-noise ratio (SNR) of the signal.

12. The UAV of claim 11, wherein to return the wireless radio to the dynamic modulation mode is further based on an SNR threshold.

13. The UAV of claim 8, wherein the UAV is further configured to capture images while in flight and encode the images into the signal.

14. The UAV of claim 8, wherein the low end of the range of possible modulation rates comprises a lowest possible modulation rate allowed by the UAV.

15. A computing apparatus comprising:
one or more computer-readable storage media; and
program instructions stored on the one or more computer-readable storage media that, when executed by one or more processors, direct a communication subsystem of an unmanned aerial vehicle (UAV) to at least:
operate a wireless radio of the UAV in a dynamic modulation mode, wherein the wireless radio, when in the dynamic modulation mode, dynamically adjusts a modulation rate of a signal within a range of possible modulation rates; and
transition the wireless radio from the dynamic modulation mode to a fixed modulation mode based at least on a current modulation rate of the signal reaching a low end of the range, wherein the wireless radio, when in the fixed modulation mode, holds the modulation rate of the signal at the low end of the range.

16. The computing apparatus of claim 15 wherein the program instructions further direct the communication subsystem of the UAV to return the wireless radio to the dynamic modulation mode based on a quality of the signal.

17. The computing apparatus of claim 16 wherein the quality of the signal is based on a signal-to-noise ratio (SNR) of the signal, and wherein the program instructions further direct the communication subsystem of the UAV to return the wireless radio to the dynamic modulation mode further based on an SNR threshold.

18. The computing apparatus of claim 15 wherein to transition the wireless radio from the dynamic modulation mode to the fixed modulation mode the program instructions further direct the communication subsystem of the UAV to determine a success ratio of a current modulation rate at the low end of the range as compared to the success ratios of one or more previous modulation rates.

19. The computing apparatus of claim 18, wherein the success ratio of a modulation rate is based on an amount of received acknowledgments generated by a receiving computing device in response to the employed modulation rate of the UAV.

20. The computing apparatus of claim 15, wherein the low end of the range of possible modulation rates comprises a lowest possible modulation rate allowed by the UAV.
